(19) United States
(12) Patent Application Publication
(10) Pub. No.: US 2012/0151321 A1
(43) Pub. Date: Jun. 14, 2012

(54) System for Generating Websites for Products with an Embedded Processor

(75) Inventors: Ronald H. Naismith, North Andover, MA (US); Sylvia Chirtic, Burlington, MA (US); Bruce Dunbar, Andover, MA (US)

(73) Assignee: Schneider Electric USA, Inc., Palatine, IL (US)

(21) Appl. No.: 12/964,411

(22) Filed: Dec. 9, 2010

(51) Int. Cl. G06F 17/00

(52) U.S. Cl. 715/234

(57) ABSTRACT

Aspects of the invention generate a website for a product with an embedded processor from a product specification, website template, and webpage definitions. The specification may contain all the properties of the product needed to interact over a network. The page definitions information identifies a subset of the parameters contained in the specification and groups the identified parameters into different webpages, menus and sub-menus. The website may have a common look and feel based on a website template that is applied to different products. Code is generated and inserted in corresponding webpages so that embedded data in can be located and formatted and may be displayed when the website is viewed by a web browser. A website generator may generate the website by creating a HyperText Markup Language file and at least one auxiliary Extensible Markup Language file from which the code may be created.

### BACKGROUND

With the automation of industrial processes and systems, e.g., control of machinery on factory assembly lines, control of chemical processes, control of heating, ventilating, and air conditioning (HVAC) systems, and control of lighting fixtures, different processes often use different products to monitor and control the different processes. For example, different firmware images and/or different product references may be used to provide the communication for different products with different operating environments. A product typically includes a controlling device with a communications interface that interacts with a specific communications environment. The communications environment may include a fieldbus supporting a designated protocol, e.g., Modbus/TCP or EtherNet/IP so that the product can interact with remote devices. With traditional systems, a different communications interface is often needed for different communications environments. Consequently, each communications environment often requires different firmware and/or hard-coded support, thus resulting in additional development effort with for each newly supported product even though there may be substantial commonality among products. In conjunction with each communications environment, a product website may be provided for each product to enable a user to install, configure, and maintain the product. However, with traditional systems, each product website may require that a developer manually create the website, including HyperText Markup Language (HTML) for each webpage, JavaScript that is used to control the look and feel of the layout, and the Java code to support applets for obtaining and displaying data for the product.

### SUMMARY

An aspect of the invention provides apparatuses, computer-readable media, and methods for generating a website for a product with an embedded processor in an automation and control system in accordance with a product specification, a website template, and webpage definitions. The specification may contain all the properties of the product needed to interact over a network. The page definitions information identifies a subset of the parameters contained in the specification and groups the identified parameters into different webpages, menus and sub-menus. The website may have a common look and feel based on a website template that is applied to different products.

With another aspect of the invention, code is generated and inserted in corresponding webpages so that data in the product can be located and may be displayed when the website is viewed by a web browser.

With another aspect of the invention, a website generator automatically generates a website by creating a web specification file and at least one auxiliary file. Code is generated from at least one auxiliary file to locate and/or format data from an product. The data may then be inserted in a corresponding webpage when viewed through a web browser. With some embodiments, the web specification file may be expressed with HyperText Markup Language (HTML) and the at least one auxiliary file may be expressed with Extensible Markup Language (XML).

With another aspect of the invention, a communication package, e.g., Modbus, BACnet, and Ethernet/IP, may be used to read and/or write data at a product or a remote device.

With another aspect of the invention, context sensitive help files (e.g., expressed with HTML) may generated in order to assist a user.

With another aspect of the invention, a product includes an embedded product host that has an embedded processor (e.g., central processing unit) and a communications device that enables the embedded product host to communicate with other devices over a network. The communications device stores a product website that enables a user to view embedded data through a web browser.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows a system with a product that supports a product website in accordance with an embodiment of the invention.

FIG. 2 shows a block diagram for a website generator that generates a website for a product in accordance with an embodiment of the invention.

FIG. 3 shows a website generator that generates different websites for different products in accordance with an embodiment of the invention.

FIG. 4 shows a flow chart for generating a website for a product in accordance with an embodiment of the invention.

FIG. 5 shows a system that generates a website for a product and that downloads the website into the product in accordance with an embodiment of the invention.

FIG. 6 shows an example of a screenshot when generating a website for a product in accordance with an embodiment of the invention.

FIG. 7 shows an example of a screenshot for a generated website for a product in accordance with an embodiment of the invention.

FIG. 8 shows a computing system for generating a website for a product in accordance with an embodiment of the invention.

FIG. 9 shows an apparatus for a communications device in accordance with an embodiment of the invention.

### DETAILED DESCRIPTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

As used herein, the term “embedded device” may be defined as a computer device or system designed to perform one task or a few dedicated functions, often with real-time computing constraints. The embedded device is embedded as part of a complete product, often including hardware and/or mechanical parts. Typically, the program instructions written for embedded devices and systems are referred to as firmware, and are stored in read-only memory or Flash memory chips. By contrast to embedded devices, a general-purpose computer, such as a personal computer (PC), is typically not embedded within another product, and is usually designed to be flexible to meet a wide range of end-user needs.

With an aspect of the invention, a website for a product with an embedded device is automatically generated in accordance with a product specification, a website template, and webpage definitions. The specification may be expressed as a standard description and may contain all the properties of the product needed to interact over a network. The page definitions information identifies a subset of the parameters contained in the specification and groups the identified parameters into different webpages, menus and sub-menus. The website may have a common look and feel based on a website template that is applied to different products.

With another aspect of the invention, code is generated and inserted in corresponding webpages so that data in the product can be located and formatted and may be displayed when the website is viewed through a web browser.

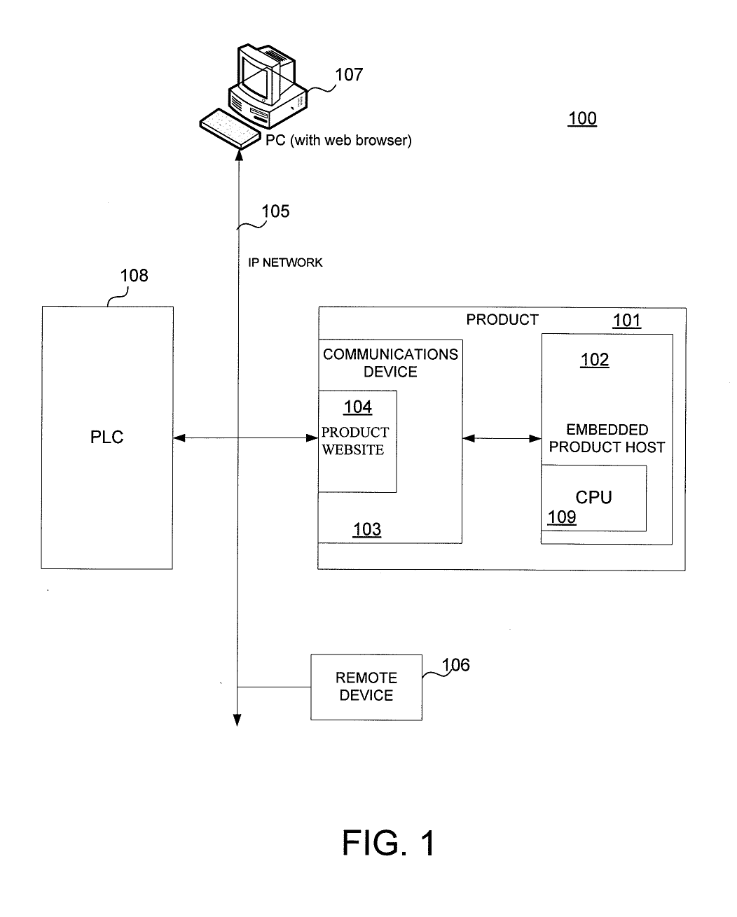

FIG. 1 shows system 100 with product 101 that supports product website 104 in accordance with an embodiment of the invention. Internet Protocol (IP) network 105 may connect programmable logic controller (PLC) 108, product 101, personal computer 107, and remote device 106. For example, PLC 108 may control remote device 106 through product 101, and a user may configure and monitor product 101 from PC 107 through a web browser by accessing product website 104. However, with some embodiments, system 100 may not encompass PLC 108, where product 101 may directly interact with remote device 106 or may encompass a different controlling device (e.g., a personal computer or mainframe computer). Product 101 may include communications device 103 that is dedicated to providing Internet Protocol (IP) communications and supporting applications. With some embodiments, communications device 103 may be a physical module that plugs into embedded product host 102 or a virtual module defined by interfaces in the embedded software. Embedded product host 102 may include an embedded processor such as embedded central processing unit (CPU) 109 in order to perform processes for product 101.

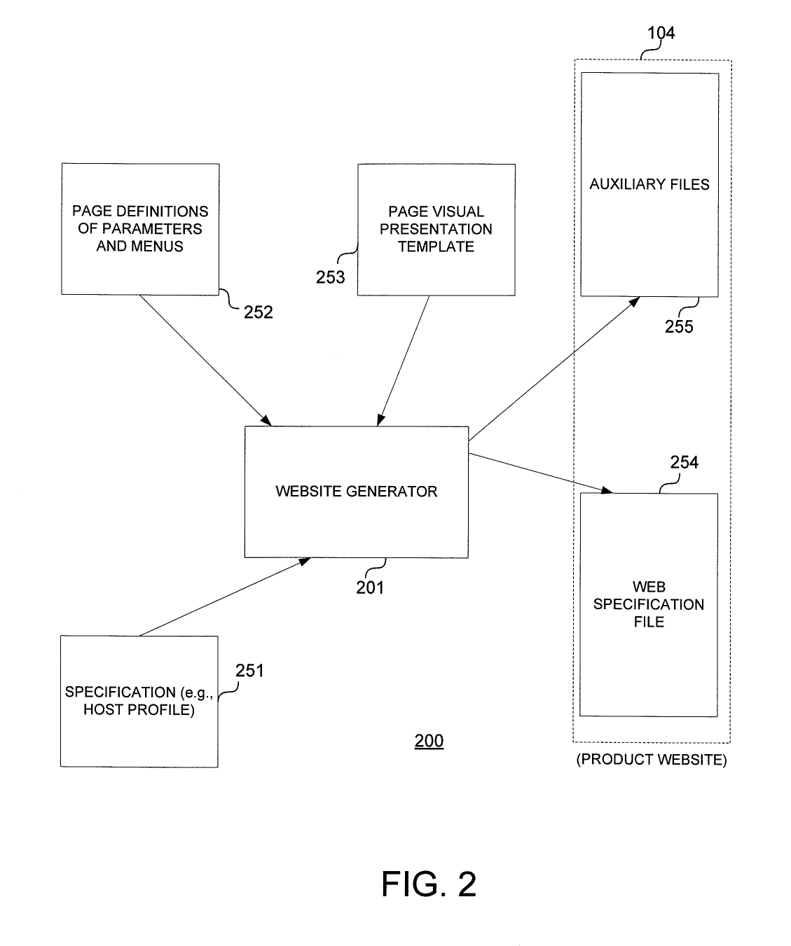

FIG. 2 shows a block diagram of system 200 that generates website 104 for product 101 (as shown in FIG. 1) in accordance with an embodiment of the invention. Website generator 201 generates website 104 that may contain multiple pages and parameters based on specification 251, page definitions 252, and page visual presentation template 253.

Specification 251 describes the properties (e.g., structure and operation) of product 101. With some embodiments, specification 251 comprises a standard product description file that contains all the properties of product 101 for interacting with PLC 108 and PC 107 over IP network 105 as well internal properties of product 101. For example, specification may comprise a profile image associated with embedded product host 102, so that communications device 103 can map a network data object received over network 105 (as shown in FIG. 1) to host data for the embedded product host 102 in accordance with the profile image. (A data object may be any data entity that can be manipulated by the commands of a programming language, such as a value, variable, function, or data structure.) Communications device 103 may then exchange the host data with embedded product host 102. Communications device 103 may subsequently interact with a different host type if a different profile image is downloaded to communications device 103.

A standard product description file for specification 251 may be a markup language file (e.g., an Extensible Markup Language (XML)) based on a schema that is used across different types of products to provide consistency while facilitating development of a product website. Using a schema enables product 101 to be described to a software package (e.g., website generator 201) so that the software package knows how to analyze and extract information from specification 251. Rather than representing the properties of product 101 in an XML format, other approaches may be used including a spreadsheet format or a flat file.

With some embodiments, page definitions 252 identifies a subset of parameters from specification 251 that are associated with different webpages of website 104. Page definitions 252 may indicate the grouping of the parameter subset into webpages, menus, and submenus and may define page rendering, controls, and navigation. Consequently, specification 251 may be interpreted as a “universe of knowledge” about product 101 while page definitions 252 indicate which subsets of the “universe of knowledge” are to be displayed on each web page in the website 104.

Page visual presentation template 253 provides a template of a “blank” website so that websites (e.g., website 104) for different products (e.g., product 101) have a common look and feel for how pages, menus, and submenus are presented in the website as generated by website generator 201. For example, a manufacturer may desire that different products are viewed in a consistent manner by a user through the associated website. Consequently, embodiments may support different types of web technologies and/or visual presentations that may include animation or graphics.

With some embodiments, website 104 includes web specification file 254 and auxiliary files 255. With an aspect of the invention, data for product 101 may be viewed in a formatted manner over the Internet. While web specification file 254 may be expressed in a HyperText Markup Language (HTML) or other type of markup language, some embodiments may not be specifically tied to a web browser. Auxiliary files 255 may be expressed in a markup language, e.g., XML. Web specification file 254 specifies each webpage of website 104 and may include pointers to code (e.g., Java applets) for including embedded data from product 101 (e.g., from embedded host 102) when rendering website 104 through a web browser. (Java applets typically execute at the client (e.g., PC 107 as shown in FIG. 1). Embodiments may support generated computer-executable code expressed as Java applets, C-sharp, and the like. Auxiliary files 255 may specify the rendering of code for providing the embedded data. With some embodiments, auxiliary files 255 may be used to generate Java code itself or may be used in conjunction with Java code to retrieve the embedded data. However, with some embodiments code may be executed at the server (communications device 103 as shown in FIG. 1) as a servlet, in which the retrieved data is sent to the client's browser from the servlet.

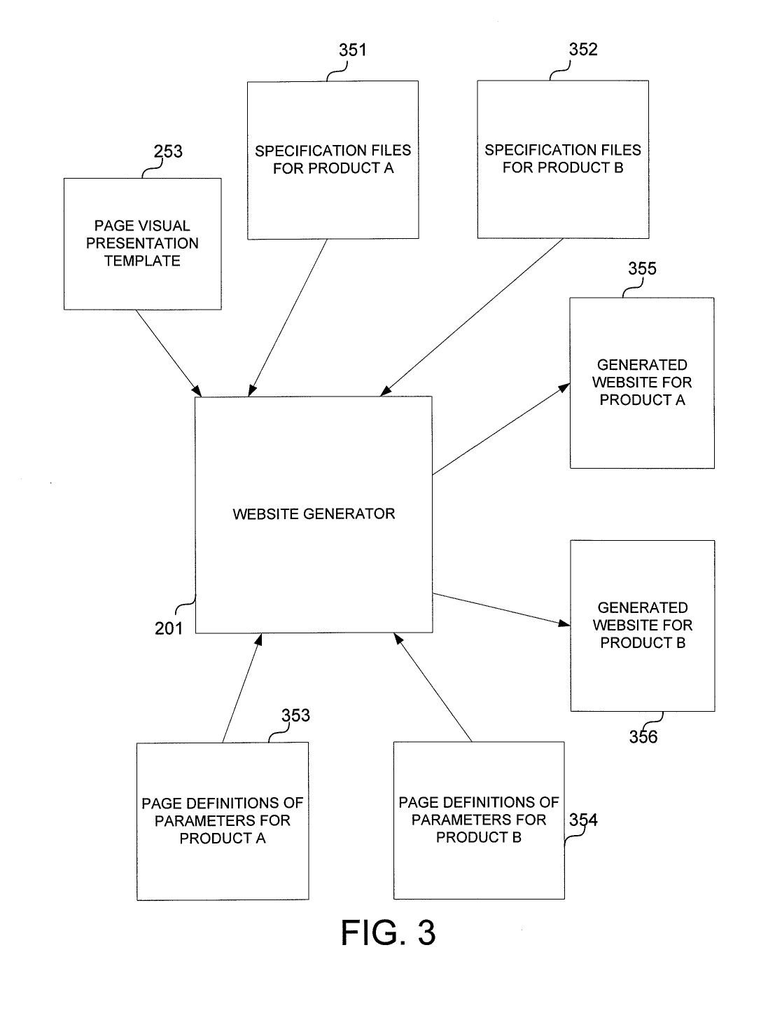

FIG. 3 shows website generator 201 that may generate different websites for different products in accordance with an embodiment of the invention. For example, different products may be developed with communications device 103 providing a common platform. For example, product descriptions for product A and for product B are contained in specifications 351 and 352, respectively. The product descriptions may map network objects and parameters into corresponding addresses within product embedded software. Based on page definitions 353 and 354, different parameter subsets from specifications 351 and 352 are extracted and inserted into webpages of websites 355 and 356, respectively. As previously discussed, a common look and feel both for websites 355 and 356 is provided by page visual presentation template 253.

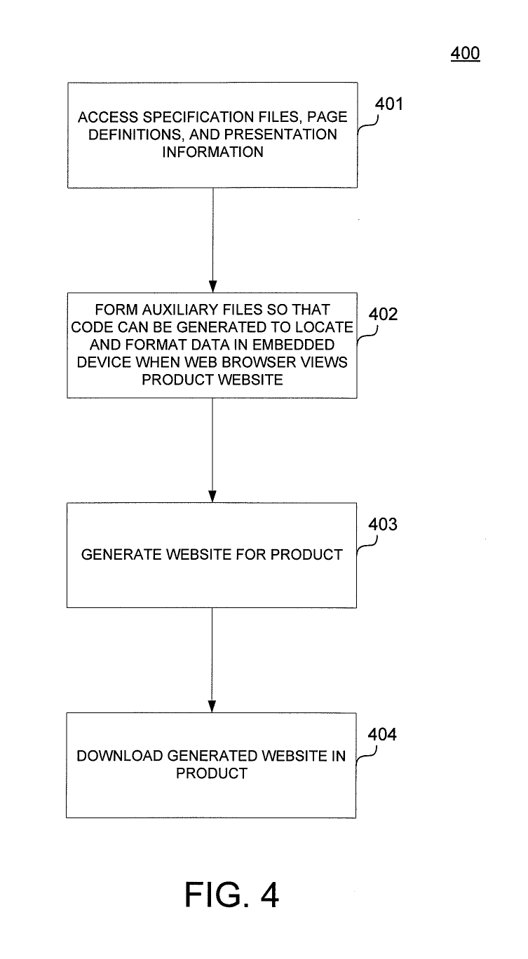

FIG. 4 shows flow chart 400 for generating website 104 (as shown in FIG. 1) for product 101 in accordance with an embodiment of the invention. At block 401, website generator 201 (as shown in FIG. 2) accesses specification file 251, page definition file 252, and page visual presentation template 253. Website generator 201 then forms auxiliary files 255 (as shown in FIG. 2) at block 402 so that code (e.g., applets) can be generated to format and locate data in product 101. Consequently, a web browser may access website 104 for remote viewing whenever formatted information is needed. Website generator 201 generates website 104 by also forming web specification file 254 at block 403. Website generator 201 may then download generated website 104 to communications device 103 at block 404. However, with some embodiments another process or development tool may download website 104 to communications device 103.

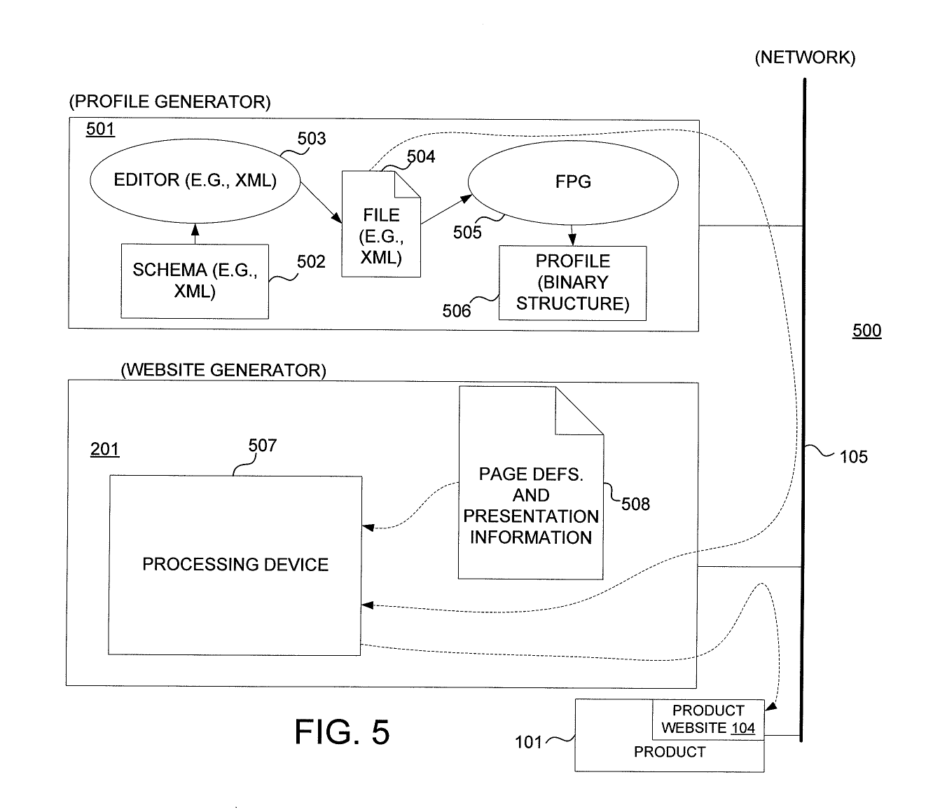

FIG. 5 shows system 500 that generates website 104 for product 101 and that downloads website 104 into product 101 in accordance with an embodiment of the invention. System 500 includes profile generator 501, website generator 201, network 105, and product 101. As previously discussed, specification 251 (as shown in FIG. 2) may comprise the host profile of product 101 and may be expressed as a verbose host profile corresponding to file 504. With some embodiments, file 504 may be expressed with a markup language, e.g., XML. File 504 may be based on schema 502, which may be edited by a user through editor 503 to modify file 504 and where schema 502 typically provides the template or “rules” for the format of the host profile.

If product 101 has a static or fixed data model, then verbose host profile 504 is typically developed once during development of the host profile. However, if the host device is programmable and the data model for the host device may change, then a mechanism may be added to the programming environment for profile generator 501 to export verbose host profile 504. Verbose host profile 504 may then be provided to fieldbus profile generator 505 in order to convert verbose host profile 504 to binary format 506 when the communications device 103 does not support a runtime parser of a markup language, e.g., XML.

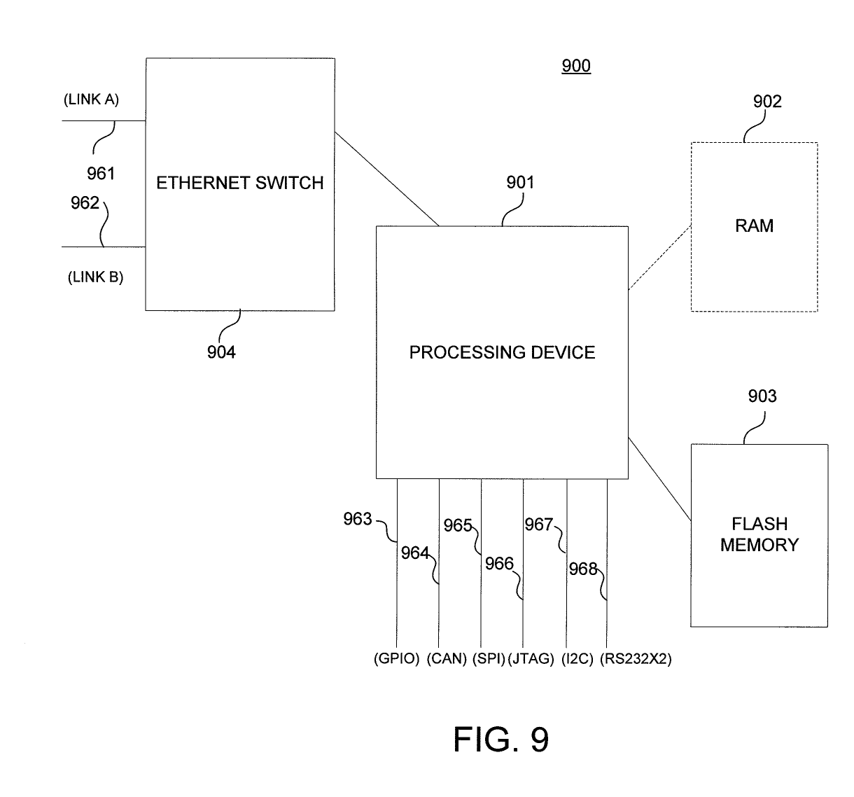

As shown in FIG. 5, website generator 201 obtains file 504 (corresponding to specification 251) and page definitions and presentation information 508 (corresponding to page definitions 252 and page visual presentation template 253 as shown in FIG. 2). Processing device 507 then processes file 504 and information 508 in accordance with flow chart 400 to obtain website 104, which may be downloaded in product 101. With some embodiments, however, website 504 may included in memory (e.g., flash memory 904 as shown in FIG. 9) when communications device 103 (as shown in FIG. 1) is manufactured so that downloading is not required.

With some embodiments, profile generator 501 and/or website generator 201 may be based on a personal computer (PC); however, other computing platforms, e.g., an embedded processing device, mainframe computer, mobile terminal device, or cloud computing platform, may be used.

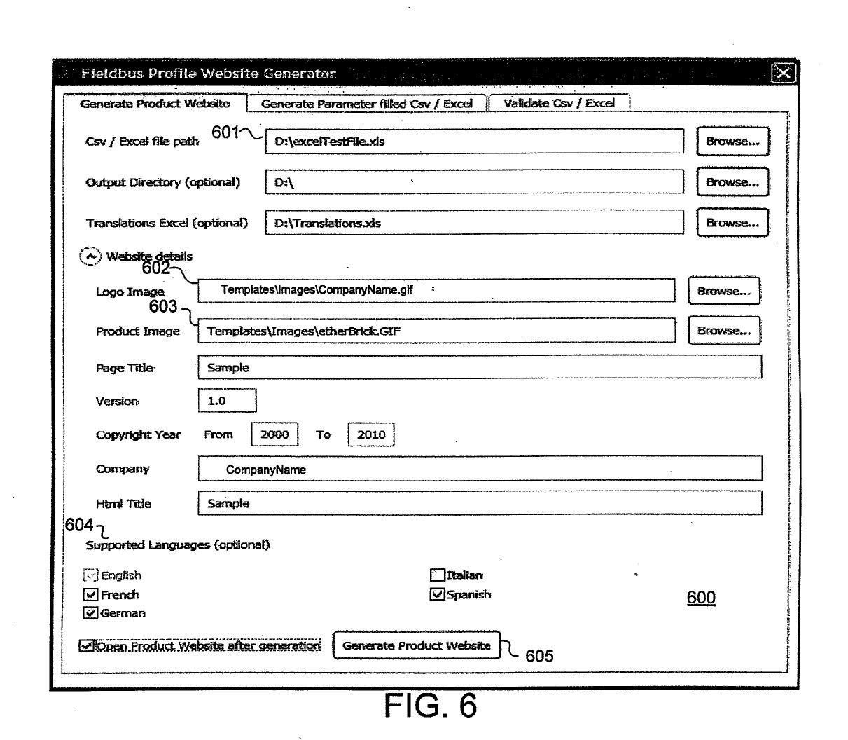

FIG. 6 shows an example of screenshot 600 when generating website 104 for product 101 in accordance with an embodiment of the invention. A developer provides page definitions information by entering file path 601 for the corresponding file. Website 104 may be further customized by identifying files with the manufacturer's logo and product's image by fields 602 and 603, respectively. Also, website 104 may support different user languages as selected through field 604.

After the developer provides the above information and activates Generate Product Website selection 605, website generator 201 automatically processes the specification files in conjunction with presentation information to complete website 104 along with code to locate and format displayed data within product 101. This approach may facilitate the effort of designing, coding, and testing a website that is embedded in a networked device. It also may improve the quality of website 104 because a large amount of editing may be eliminated along with the potential for errors.

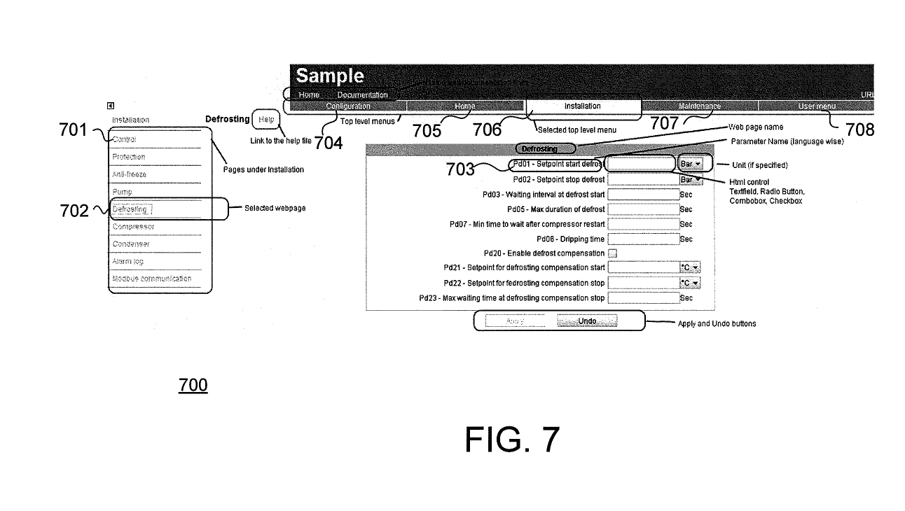

FIG. 7 shows an exemplary screenshot 700 for generated website 104 for product 101 in accordance with an embodiment of the invention. Screenshot 700 shows the webpage when a user has selected defrosting selection 702 after selecting installation selection 706 in the top view menu. Other webpages may be displayed through the web browser by the user selecting other selections (e.g., 704, 705, 707, or 708 in the top view menu or control 701 when installation selection 706 is selected.) For each webpage a different set of embedded data may be displayed. For example, set point start defrost value 703 as well as other configured values may be retrieved from embedded host 102. Also, data may be written to product 101 and/or remote device 106 through website 104.

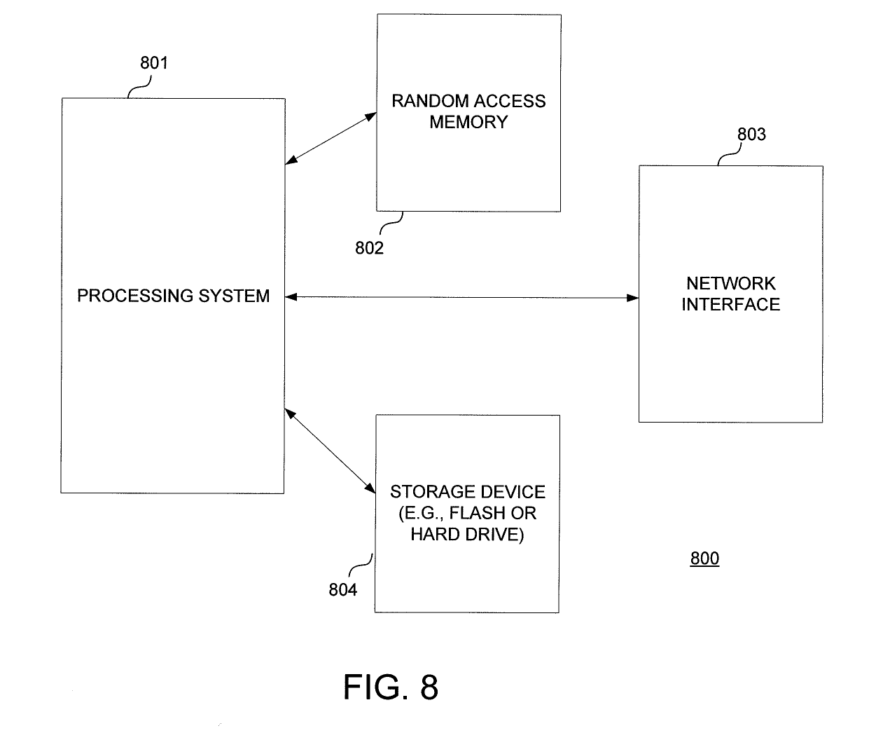

FIG. 8 shows apparatus 800 for generating website 104 for product 101 in accordance with an embodiment of the invention. Processing system 801 may execute computer executable instructions from a computer-readable medium (e.g., storage device 804) in order provide communications over network 105 and to map network data objects to host data. Memory 802 is typically used for temporary storage while storage device 804 may comprise a flash memory and/or hard drive for storing computer executable instructions and a profile image. However, computer storage media may include volatile and nonvolatile, removable and non-removable media implemented in any method or technology for storage of information such as computer readable instructions, data structures, program modules or other data. Computer storage media include, but may not be limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processing system 801. The executable instructions may carry out any or all of the method steps described herein.

With some embodiments, processing system 801 may correspond to one or more processors and storage device 804 may correspond to one or more memories.

Apparatus 800 may be implemented as one or more ASICs or other integrated circuits having instructions for performing operations as described in connection with one or more of any of the embodiments described herein. Said instructions may be software and/or firmware instructions stored in a machine-readable medium and/or may be hard-coded as a series of logic gates and/or state machine circuits in one or more integrated circuits and/or in one or more integrated circuits in combination with other circuit elements.

FIG. 9 shows apparatus 900 for communications device 103 as shown in FIG. 1 in accordance with an embodiment of the invention. Processing device 901 may execute computer executable instructions from a computer-readable medium (e.g., memory 903) in order to provide communications over network 105 and to map network data objects to host data. With some embodiments, processing device 901 may include a processor and an internal random access memory (RAM) 902. Memory 902 is typically used for temporary storage while memory 903 may comprise a flash memory for storing computer executable instructions and a profile image. However, computer storage media may include volatile and nonvolatile, removable and non-removable media implemented in any method or technology for storage of information such as computer readable instructions, data structures, program modules or other data. Computer storage media include, but may not be limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 901. The executable instructions may carry out any or all of the method steps described herein.

With some embodiments, processor 901 may correspond to one or more processors and memory 903 may correspond to one or more memories.

Product website 104 (as shown in FIG. 1) may be stored in memory 903 so that a web browser executing at PC 107 can view product website 104.

Apparatus 900 may be implemented as one or more ASICs or other integrated circuits having instructions for performing operations as described in connection with one or more of any of the embodiments described herein. Said instructions may be software and/or firmware instructions stored in a machine-readable medium and/or may be hard-coded as a series of logic gates and/or state machine circuits in one or more integrated circuits and/or in one or more integrated circuits in combination with other circuit elements.

Apparatus 900 may support a dual Ethernet links 961 and 962 to provide redundancy typically used with network 105 to monitor and control remote devices. Processing device 901 may obtain the active Ethernet link through Ethernet switch 904

Apparatus 900 may also support other interfaces 963-968 that may be used for direct communications between communications device 103 and host 102 (as shown in FIG. 1). Interfaces 963-968 may support different interface types that include General Purpose Input/Output (GPIO), Controller-Area Network (CAN), System Packet Interface (SPI), Joint Test Action Group (JTAG), Inter-Integrated Circuit (I2C), and Recommended Standard 232 (RS-232).

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for forming a first product website in a first product that includes an embedded device, the method comprising:
obtaining first specification information, first webpage definition information, and presentation information;
generating a first set of computer-executable instructions to locate first data from the embedded device in accordance with the first specification information and the first webpage definition information;
generating the first product website from the first specification information, the first webpage definition information, and the presentation information; and
providing the first data through the first product website when viewed by a web browser.

2. The method of claim 1, further comprising:
obtaining second specification information and second webpage definition information;
generating a set of second computer-executable instructions to locate second data in a second product in accordance with the second specification information and the second webpage definition information;
generating the a second product website from the second specification information, the second webpage definition information, and the presentation information; and
providing the second data through the second product website viewed by the web browser.

3. The method of claim 1, wherein the first product includes a communications device, the method further comprising:
retrieving, by the communications device, the first data from the embedded device.

4. The method of claim 1, further comprising:
downloading the first product website to the first product.

5. The method of claim 4, further comprising:
storing the first product website on the communications device.

6. The method of claim 1, further comprising:
selecting a subset of the first specification information based on the first webpage definition information.

7. The method of claim 1, further comprising:
generating an auxiliary file and a web specification file from the first specification information, the first webpage definition information, and the presentation information; and
utilizing the auxiliary file to locate the first data from the embedded device

8. The method of claim 7, further comprising:
specifying a rendering of at least one application from the auxiliary file when the first product website is viewed.

9. The method of claim 2, further comprising:
reconfiguring the communications device with the second product:
downloading the second product website to the second product; and
storing the second product website on the communications device.

10. The method of claim 7, wherein the generating the first set of computer-executable instructions to locate the first data comprises:
generating computer-executable code from the auxiliary file to locate the first data.

11. An apparatus comprising:
at least one processor; and
at least one memory having stored therein machine executable instructions, the at least one memory and stored instructions configured to, with the at least one processor, cause the apparatus to:
obtain first specification information, first webpage definition information, and presentation information;
generate a first set of computer-executable instructions to locate first data from an embedded device of a first product in accordance with the first specification information and the first webpage definition information, wherein the first data is provided when the first product website is viewed by a web browser;
generate the first product website from the first specification information, the first webpage definition information, and presentation information; and
download the first product website to the first product.

12. The apparatus of claim 11, the at least one memory and stored instructions are further configured to, with the at least one processor, cause the apparatus to:
obtain second specification information and second webpage definition information;
generate a second set of computer-executable instructions to locate second data in a second product in accordance with the second specification information and the second webpage definition information;
generate the a second product website from the second specification information, the second webpage definition information, and the presentation information; and
download the second product website to the second product.

13. The apparatus of claim 11, the at least one memory and stored instructions are further configured to, with the at least one processor, cause the apparatus to:
select a subset of the first specification information based on the first webpage definition information.

14. The apparatus of claim 11, the at least one memory and stored instructions are further configured to, with the at least one processor, cause the apparatus to:
generate an auxiliary file and a web specification file from the first specification, first webpage definition information, and the presentation information; and
utilize the auxiliary file to locate the first data from the embedded device.

15. The apparatus of claim 14, the at least one memory and stored instructions are further configured to, with the at least one processor, cause the apparatus to:
generate computer-executable code from the auxiliary file to locate the first data.

16. A computer-readable storage medium storing computer-executable instructions that, when executed, cause a processor to perform a method comprising:
obtaining first specification information, first webpage definition information, and presentation information;
generating a first set of computer-executable instructions to locate first data from an embedded device of a first product in accordance with the first specification information and the first webpage definition information, wherein the first data is provided when the first product website is viewed by a web browser;
generating the first product website from the first specification information, the first webpage definition information, and presentation information; and
downloading the first product website to the first product.

17. The computer-readable storage medium of claim 16, the method further comprising
obtaining second specification information and second webpage definition information;
generating a second set of computer-executable instructions to locate second data in a second product in accordance with the second specification information and the second webpage definition information;
generating the a second product website from the second specification information, the second webpage definition information, and the presentation information; and
downloading the second product website to the second product.

18. The computer-readable storage medium of claim 16, the method further comprising
selecting a subset of the first specification information based on the first webpage definition information.

19. The computer-readable storage medium of claim 16, the method further comprising
generating an auxiliary file and a web specification file from the first specification information, first webpage definition information, and the presentation information; and
utilizing the auxiliary file to locate the first data from the embedded device.

20. The computer-readable storage medium of claim 16, the method further comprising
generating computer-executable code from the auxiliary file to locate the first data.
